(19) United States
(12) Patent Application Publication
(10) Pub. No.: US 2010/0073331 A1
(43) Pub. Date: Mar. 25, 2010

(54) DISPLAY SYSTEM

(76) Inventor: Ali Kord, Brighton (GB)

Correspondence Address: GREGORY SMITH & ASSOCIATES, 3900 NEWPARK MALL ROAD, 3RD FLOOR, NEWARK, CA, 94560, US

(21) Appl. No.: 12/522,255

(22) PCT Filed: Jan. 3, 2008
(86) PCT No.: PCT/GB08/00014

§ 371 Date: Dec. 1, 2009

(30) Foreign Application Priority Data
Jan. 5, 2007 (GB) 0700163.9

(51) Int. Cl. G06Q 30/00; G06F 3/033; G09G 5/00; G06Q 20/00

(52) U.S. Cl. 345/184; 715/863; 345/156; 705/27

(57) ABSTRACT

The present invention relates to a display booth (1) for displaying a virtual puppet. The display booth (1) comprises a motion tracking system (3) for tracking the movements of an operator in the display booth (1) and a processor (5) is provided for generating the virtual puppet. A keyboard and a separate controller (7) operable by the operator to control the virtual puppet are also provided. The present invention also relates to a method of generating a virtual puppet. Furthermore, the present invention relates to an interactive system for placing an order, such as a food or drinks order. The interactive system comprises one or more virtual puppet display systems.

The present invention relates to a display system for displaying a computer generated character. More particularly, the present invention relates to a display booth for displaying a virtual puppet. The present invention also relates to a method of generating a virtual puppet.

It is known to present a computer generated character on screen and use appropriate control techniques to enable the character to interact with an audience in real time. These computer generated characters, referred to herein as “virtual puppets”, may be used at exhibitions and the like as advertising and promotional tools. A known system is the VActor™ system supplied by SimGraphics of 1441 Huntington Drive #3470, South Pasadena, Calif., USA (http://www.simg.com).

There are, however, drawbacks with known virtual puppet systems. Significantly, known systems require a team of two or more people to provide a fully animated character. An actor typically provides the voice for the character and controls some movements whilst an operator refines the control, for example by changing facial expressions of the character. The operator typically uses a conventional keyboard to perform these additional control functions. The space required to accommodate an actor and a second operator restricts the applications for these types of systems. Moreover, the need for a team of people to operate the system increases the operational costs.

To address these drawbacks, simplified control techniques may be employed, for example using a handheld controller. However, these techniques typically rely on scripted animations and this reduces the movements that can be represented.

The present invention, at least in, preferred embodiments, attempts to overcome or ameliorate at least some of the above problems.

Viewed from a first aspect, the present invention relates to a display booth for displaying a virtual puppet, the booth comprising a motion tracking system for tracking the movements of an operator in the display booth, a processor for generating the virtual puppet, a keyboard and a controller operable by the operator to control the virtual puppet, wherein said controller is separate from the keyboard. In use, the operator's movements may be mapped onto the virtual puppet to provide corresponding movements. The controller may be operable simultaneously with the tracking system to enable further control or refinement of the virtual puppet's movements. The controller may enable the appearance of the virtual puppet to be changed, for example to represent different emotions or to change the facial expression of the virtual puppet.

In use, the tracking system may track at least some of the operator's movements and transfer the tracked movements onto the virtual puppet. In use, the virtual puppet may perform movements corresponding to those performed by the operator. The tracking system preferably tracks the movement of at least one of the operator's limbs and/or the operator's head. The controller is preferably operable by the operator at the same time as the tracking system to enable additional control. The controller preferably enables the movement of the virtual puppet to be refined and/or the appearance of the virtual puppet to be changed.

At least in preferred embodiments, the controller may be utilised to change the appearance of the virtual puppet with little or no corresponding movement of the virtual puppet. If the operator had to use a keyboard to initiate the changes in appearance of the virtual puppet, the system would track the operator's movements and these would be mapped to the virtual puppet.

Advantageously, at least in preferred embodiments, the booth according to the present invention may be operated by a single operator. Although the booth could be adapted to be used by a single person, this is not essential. In certain circumstances, it may be desirable to provide a booth adapted for use by two or more people.

The processor is preferably provided in the booth and is preferably suitable for generating a virtual puppet at least substantially in real-time.

The controller may be a remote control. In use, the controller is preferably operated by hand. Preferably, the controller is hand-held. In use, the controller may be carried or supported by the operator, for example in their hand. The controller may be provided with attachment means, such as one or more straps, for attaching the controller to an operator's hand. Alternatively, the controller may be provided on a glove.

The controller preferably comprises a switch, a joystick, a jog wheel, dial or other selection device.

In use, a connection is preferably established between the controller and the processor. The connection may be provided by a lead or cable, but is preferably wireless.

The controller is preferably operable to change the appearance of the virtual puppet to represent different moods. By way of example, the controller may be operated to change the appearance of the virtual puppet to represent happiness, sadness or anger. Equally, the controller may be used to change the appearance of the virtual puppet to represent different facial expressions. The operator could, for example, change the appearance of the virtual puppet to express confusion or embarrassment. In preferred embodiments, the operator may use the controller seamlessly to change between the different moods or facial expressions, depending on the situation. Furthermore, the controller may control the movement of the eye(s) of the virtual puppet.

The booth may be provided with a plurality of controllers.

A camera for tracking the operator's movements or expressions could also be employed, but it will be appreciated that this may increase the complexity of the booth.

The controller could also be operable to initiate different animation sequences, special effects or to trigger scripted events. These may be applied directly to the virtual puppet or may affect a virtual environment in which the virtual puppet is placed.

The motion tracking system preferably comprises at least one inertial sensor, such as an accelerometer. Preferably, a plurality of inertial sensors is provided. In use, the at least one inertial sensor is provided on the person of the operator. In use, at least one inertial sensor is preferably located on each limb of the operator to be mapped onto the virtual puppet. In use, an inertial sensor is preferably provided on each side of the operator's joints.

The motion tracking system preferably comprises a plurality of receivers for receiving a signal transmitted from a transmitter. In use, the transmitter may be provided on the person of the operator. The tracking system may monitor the position of the transmitter to provide a reference point. This reference point may be used to determine the relative positions of other sensors. The transmitter may be an optical transmitter, a sonic transmitter or a radio transmitter.

Alternatively, the motion tracking system may comprise a plurality of transmitters. A receiver is preferably provided on the person of the operator for receiving signals transmitted from said transmitters is provided. The receiver may determine its relative position to provide a reference point. For example, sound at different frequencies may be emitted from the transmitters simultaneously (or at predetermined times or intervals) and the relative time at which the different frequencies detected by the receiver used to determine the relative position of the receiver. The transmitters may be optical transmitters, sonic transmitters or radio transmitters.

Rather than performing dynamic tracking, the reference point may be fixed at a predetermined point within the booth. For example, the reference point may be set in relation to the position of a seat within the booth. If the seat is movable, the position and/or orientation of the seat may be monitored to provide the required reference point.

A microphone is preferably provided in the booth. The microphone is preferably used to allow the operator to speak on behalf of the virtual puppet. The operator's voice may be altered before it is output. Preferably, the processor provides lip-synching for the virtual puppet in response to sounds detected by the microphone. The lip-synching may, for example, be provided . using software running on the processor. At least one loud speaker is preferably provided for outputting the “voice” of the virtual puppet.

The keyboard may be movably mounted in the booth. Preferably, the keyboard is movable together with a seat. The position of the keyboard relative to the seat preferably remains substantially unchanged irrespective of the orientation or position of the seat. Thus, the operator may rotate the seat to change the orientation of the virtual puppet but remain satisfied that the relative position of the keyboard will remain unchanged.

A camera is preferably mounted on the booth for relaying images from outside the booth to a monitor or screen inside the booth.

The processor preferably outputs the virtual puppet to a display. The display is preferably mounted on the outside of the booth. The display may be a projector, but is preferably a screen, such as an LCD or plasma screen. A screen may also be provided in the booth to enable the operator to view the virtual puppet.

Side panels are preferably provided to define a viewing area for the display. The side panels preferably project forward on each side of the display. This helps to reduce the area in which people view the display and may make interaction with the audience easier for the operator.

The virtual puppet may be superimposed on a live video feed of an audience or may be displayed in front of a computer generated background.

The booth may be a standalone unit having one or more proximal displays, typically mounted on the outside of the booth itself. Alternatively, one or more remote displays may be connected to the booth. This may be desirable to increase the impact of the booth, for example in an exhibition. A camera may be associated with each display to enable the operator to see people at each display and preferably also to interact with them.

Preferably, the operator may selectively idle (or disable) one or more of the displays. In use, a “live” performance of the virtual puppet is preferably only displayed on one or more active displays (i.e. displays that have not been idled). A display selector may be provided to allow the operator to select the display(s) on which the live animation is displayed; and/or to select the display(s) to be idled. A display that has been idled preferably displays the virtual puppet performing a stored or pre-recorded animation sequence.

The booth could be connected to at least one remote display over a LAN, WAN or the internet. A wireless connection may be established between the booth and the at least one remote display. A camera may be provided with the or each remote display. The camera(s) may be connected to a monitor in the booth over a LAN, WAN or the internet.

Viewed from a further aspect, the present invention relates to a display booth comprising a motion tracking system for tracking the movements of an operator in the booth, a processor for generating a virtual puppet, and a remote control operable by the operator to control the virtual puppet.

Viewed from a still further aspect, the present invention relates to a virtual puppet booth operable by a single person. The booth is preferably provided with a motion tracking system to track the movements of said person.

Viewed from a yet further aspect, the present invention relates to a method of generating a virtual puppet, the method comprising the steps of:
(a) tracking the movements of an operator;
(b) mapping the movements of the operator onto the virtual puppet; and
(c) controlling the virtual puppet in response to operator inputs in a remote control.

The remote control is preferably operable without requiring the operator to make movements that are tracked. The remote control may enable the movement of the virtual puppet to be refined; and/or the appearance of the virtual puppet to be changed.

The virtual puppet may be displayed on a local display, for example in the same room as or proximal the operator. Alternatively, the virtual puppet may be displayed on at least one remote display. The at least one remote display may be connected over a LAN, a WAN or the internet.

The virtual puppet may be displayed on a plurality of displays. The, displays may be local and/or remote. A camera may be associated with each display.

The movements of the operator may be mapped onto a plurality of virtual puppets. One or more different virtual puppets may be generated. The operator's movements may simultaneously be mapped onto different virtual puppets. The appearance of the virtual puppets may be modified, for example using different colours, to generate the different virtual puppets. Alternatively, completely different models may be used to generate the different virtual puppets.

The method may be used in a retail environment in which a customer may interact with the virtual puppet, for example to discuss a potential purchase. Equally, the method may be employed in an eatery, such as a café, restaurant, bar, fast food outlet or drive-through outlet. It is envisaged that a display may be provided at a table to allow one or more customers seated at that table to interact with the virtual puppet. A loudspeaker and/or microphone would preferably be associated with each table to enable communication between the operator and the customer(s). In use, the customer(s) may, for example, ask questions about the menu and, in due course, place a food order. The method could also be employed for ordering drinks or to buy merchandise or goods.

Preferably, a camera is associated with each display to allow the virtual puppet operator to view the customer(s). Preferably, the customer(s) may disable the display and/or camera. Furthermore, the method may include sending a signal to the operator, for example to indicate that a customer requires service or has a query.

The method may include the additional step of accepting a payment. A customer may make the payment, for example using a credit or debit card, in response to prompts on said display.

Viewed from a still further aspect, the present invention relates to a display booth comprising a motion tracking system for tracking the movements of an operator in the booth, a processor for generating a virtual puppet, a seat and a keyboard operable by the operator to change the appearance of the virtual puppet, wherein the keyboard and the seat are movable together. The position of the keyboard relative to the keyboard preferably remains substantially unchanged when the seat is moved. The seat may be slidably and/or rotatably mounted.

Viewed from a yet further aspect, the present invention relates to a display system for displaying a virtual puppet, the system comprising a motion tracking system for tracking the movements of an operator, a processor for generating the virtual puppet, a keyboard and a controller operable by the operator to control the virtual puppet, wherein said controller is separate from the keyboard. In use, at least some of the operator's movements may be mapped onto the virtual puppet and the controller may simultaneously be used to refine the movements of the virtual puppet and/or to change its appearance.

The controller preferably enables control of the virtual puppet independently of the keyboard. At least in preferred embodiments, the controller may be utilised to change the appearance of the virtual puppet with little or no corresponding movement of the virtual puppet.

Viewed from a yet further aspect, the present invention may relate to a display system comprising a motion tracking system for tracking the movements of an operator, a processor for generating a virtual puppet, and a remote control operable by the operator to control the virtual puppet.

The above display systems could be provided with a plurality of controllers.

The above display systems could be incorporated into a booth of the type described herein.

The display systems described herein could be used in a retail outlet and a customer may interact with the virtual puppet, for example to discuss a potential purchase or even to make the purchase. The display system according to the present invention may also be used for ordering drinks, or to purchase goods or merchandise.

Equally, the display systems may be employed in an eatery, such as a café, restaurant, fast food outlet or drive-through outlet. In use, the virtual puppet may be displayed on at least one display. A display may be provided at a table to allow one or more customers seated at that table to interact with the virtual puppet. Preferably, a plurality of displays is provided and each display may be associated with a different table.

Preferably, a camera is associated with each display to allow the virtual puppet operator to view the customer(s). Preferably, disabling means is provided to allow the customer(s) to disable the display and/or camera. An alerter device may be provided to enable a customer to send a signal to the operator, for example to indicate that they require service or have a query.

A loudspeaker and/or microphone is/are preferably provided at each table to enable communication between the operator and the customer(s).

In use, the operator may be located in a booth of the type described herein or in a room on the premises. However, it will be appreciated that the operator is not necessarily on the premises and may be in a separate location and connected to the display systems remotely, for example over a network such as the Internet.

The provision of an interactive food or drink ordering system comprising at least one virtual puppet display system is believed to be patentable independently. Viewed from a further aspect, the present invention relates to an interactive system for placing an order, the system comprising at least one virtual puppet display system. Preferably, the interactive system comprises a plurality of said virtual puppet display systems. A selection means may be provided to enable an operator to select which display is active. An order may be placed for food, drink or goods. The interactive system may be provided with payment receiving means.

A virtual puppet may be generated to operate as an interactive waiter in a restaurant or other eatery. Alternatively, the interactive system may be suitable for use in a retail environment to generate a virtual puppet to act as an assistant for customers.

The virtual puppet display systems are preferably of the type described herein, although it is not essential that a motion tracking system and/or a separate controller be provided.

Alternatively, a display system of the type described herein may be used as a remote receptionist, for example in an office or factory. Viewed from a still further aspect, the present invention relates to a remote receptionist system comprising a processor for generating a virtual puppet and at least one display for displaying said virtual puppet. Advantageously, an operator may be located remotely from the display.

A motion tracking system is preferably provided for tracking the movements of an operator. The movements of a single operator may be tracked to generate motion data for the animation of virtual puppets to be displayed on one or more sites. The remote receptionist may be displayed at several sites in a single company and/or may be displayed at the sites of several different companies.

In use, different virtual puppets may be displayed on different displays. A first virtual puppet may be displayed on a first display or a first set of displays; and a second virtual puppet may be displayed on a second display or a second set of displays.

Selection means is preferably provided to enable the operator to select an active display or to idle one or more displays.

The display system preferably comprises a signalling device to enable a visitor or other individual to signal the operator.

Viewed from a yet still further aspect, the present invention relates to a display system comprising a motion tracking system for tracking the movements of an operator and a processing means for generating at least one virtual puppet for display on a plurality of displays; wherein a selector is provided for selecting one or more of said displays to be idled and/or activated.

Viewed from a still further aspect, the present invention relates to a display system comprising a motion tracking system for tracking the movements of an operator and a processing means for generating a first virtual puppet for display on a first display and a second virtual puppet for display on a second display. The first and second virtual puppets are preferably different from each other and may be displayed simultaneously on said first and second displays. The processing means may be suitable for generating more than two virtual puppets.

In use, the tracked movements of the operator may be used to animate said first and second virtual puppets. The tracked movements may simultaneously be applied to said first and second puppets. Alternatively, a selector may be provided to idle one or more displays. Thus, the operator may select which of said virtual puppets is animated.

The display system may comprise more than two displays. Moreover, the processing means may be suitable for generating more than two virtual puppets for display on said plurality of displays.

The term virtual puppet used herein is intended to mean a computer generated character and the term virtual actor could be used in its place. The movements of the virtual puppet are typically modelled, mapped or related to those of an operator. It will be appreciated that the virtual puppet may be a cartoon character, mascot, avatar, virtual actor or other computer generated character.

The term processor used herein refers to any suitable processing means. The processor may comprise a plurality of processing units. The processing units may be proximal to each other or they may be remote from each other and connected over a network.

The present invention further relates to a computer programmed to perform the method described herein. Moreover, the present invention relates to storage media containing a computer program to perform the method steps described herein.

A preferred embodiment of the present invention will now be described, by way of example only, with reference to the accompanying Figure.

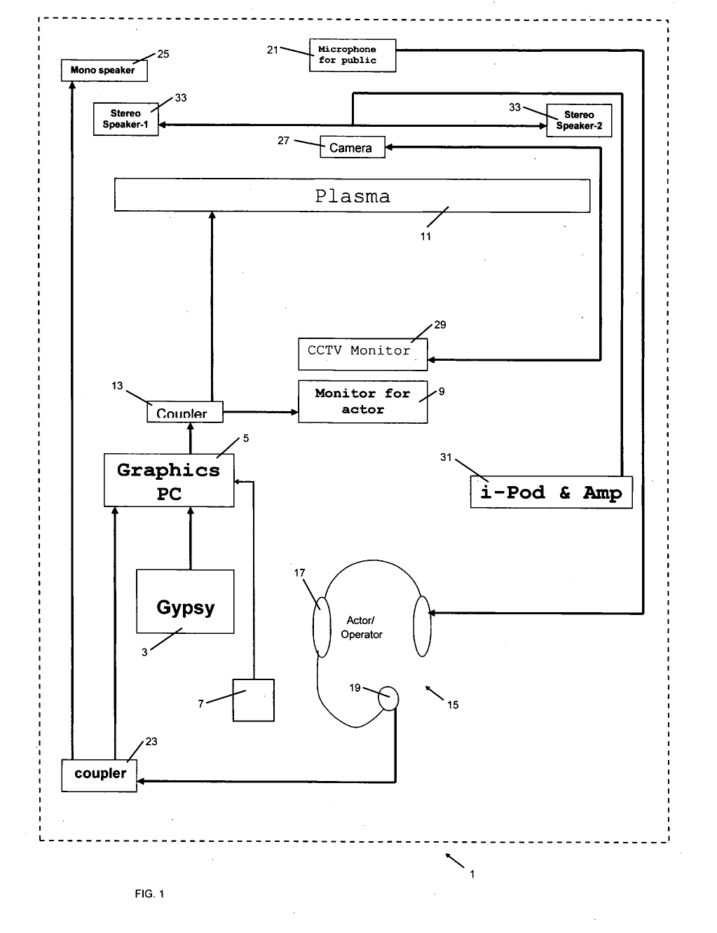

FIG. 1 shows a schematic view of a display booth in accordance with a preferred embodiment of the present invention.

A display booth 1 for displaying a virtual puppet in accordance with the present invention is shown schematically in FIG. 1. The display booth 1 provides a chamber for accommodating an operator (not shown).

A motion tracking system 3 is provided for tracking the movements of the operator which are then mapped onto the virtual puppet. The motion tracking system 3 comprises a plurality of inertial sensors or accelerometers provided in a harness to be worn by the operator. In the present embodiment, the harness is provided with separate inertial sensors for the operator's head and torso, and for each hand, forearm and upper arm (eight inertial sensors in total). Thus, the motion tracking system 3 tracks the movements of the upper part of the operator's body. A suitable motion tracking system 3 is the Gypsy Gyro™ system supplied by Animazoo UK Ltd., of Quayside Offices, Basin Road South, Brighton BN41 1WF (www.animazoo.com).

A fixed reference point is defined within the chamber, for example with reference to the position of a seat on which the operator sits when performing. Alternatively, the reference point may be tracked dynamically, for example using wireless or mechanical tracking.

The data from the motion tracking system 3 is sent to a computer 5, such as a graphics personal computer. The computer 5 is programmed to generate the virtual puppet and uses the motion tracking data to control the movements of the virtual puppet. For example, if the operator performs an action, such as raising an arm, the movement will be tracked by the motion tracking system 3 and the computer 5 will map the tracked movement onto the virtual puppet so that it performs the same action.

The computer 5 is provided with a keyboard to allow control of the processor.

A hand-held controller 7, separate from the computer keyboard, is provided to enable the operator to perform additional controls of the virtual puppet. The controller 7 may, for example, be used to change the appearance of the virtual puppet to represent different moods or facial expressions. The controller 7 is preferably wireless and comprises a miniature joystick to allow the operator to cycle through options displayed on a first internal monitor 9. Since the motion tracking system 3 does not track movements of the operator's hand, the controller 7 can be used with no or relatively small movements being tracked. Thus, the appearance of the virtual puppet may be changed with relatively small movements.

The computer 5 displays the virtual puppet on a plasma screen 11 mounted on the front of the display booth 1. A first coupler 13 is provided to enable the virtual puppet also to be displayed on the first internal monitor 9 to be viewed by the operator. Side panels (not shown) are provided on each side of the plasma screen 11 to define a display area in which an audience may gather.

A headset 15 comprising headphones 17 and an internal microphone 19 are provided in the display booth 1 for the operator. The headphones 17 are connected to an external microphone 21 provided outside the display booth 1 to enable the operator to hear comments from the audience. The internal microphone 19 is connected to a second coupler 23 and allows the operator to speak on behalf of the virtual puppet. The second coupler 23 is connected to the computer 5 to enable the virtual puppet to be animated using appropriate lip-synching technology. The operator's speech is output through an external loud speaker 25.

An external close circuit camera 27 is provided on the outside of the display booth 1 and provides a display on a second internal monitor 29. The external camera 27 is directed towards the display area to allow the operator to view the audience.

A sound system 31, such as an mp3 player and amplifier, is connected to external stereo speakers 33 to enable pre-recorded music and/or sound effects to be played.

A seat (not shown) is provided in the display booth 1. The seat is preferably slidably and/or rotatably mounted. The computer keyboard is preferably movably mounted so as to move together with the seat. Thus, the position of the keyboard relative to the seat remains substantially unchanged irrespective of the position and/or orientation of the seat. The computer 5 may be provided with a display monitor and this may also be movable together with the seat.

The operation of the display booth 1 will now be described.

The operator wears the harness housing the inertial sensors and movements are tracked by the motion tracking system 3 and transmitted to the computer 5. The computer 5 generates and displays the virtual puppet on the screen 11. The tracked movements of the operator are mapped onto the virtual puppet so that its movements follow those of the operator.

The operator may further refine the actions and appearance of the virtual puppet using the controller 7. For example, the operator may change the appearance of the virtual puppet to represent happiness, sadness or anger. The controller 7 effectively allows remote control of predetermined characteristics of the virtual puppet. At least in preferred embodiments, this enables a single operator to operate the display booth.

The operator speaks into the internal microphone 19 and this is lip-synched onto the virtual puppet so that it appears to speak in time with the voice output through the external speaker 25.

The external microphone 21 allows the operator to hear the audience through the headset 15. Thus, the operator may respond to comments or questions from the audience using the microphone 19.

The operator can see the audience on the second internal monitor 29. Thus, the operator can customise their movements, and hence those of the virtual puppet, in response to the actions of the audience.

By using the audio and visual information presented inside the booth, the operator can control the virtual puppet to appear to interact with the audience.

The embodiment of the display booth 1 has been described as having a single screen 11 on which the virtual puppet is displayed. The display booth 1 may be connected to one or more additional screens or displays for displaying the virtual puppet. The additional screen(s) or display(s) may be proximal or distal to the display booth 1. An external camera may be associated with each additional screen or display to relay images to the operator in the display booth 1. The booth may be connected to the additional screen(s) or display(s) over a LAN, WAN or the internet.

Although the preferred embodiment has been described with reference to a booth, the present invention is not limited to this application and the virtual puppet display system may be more widely applicable. For example, it is envisaged that an interactive food or product ordering system could be implemented utilising a plurality of the virtual puppet display systems described herein.

It will be appreciated that various changes and modifications may be made to the display booth described herein without departing from the spirit and scope of the present invention.

1-48. (canceled)

49. A method of generating a virtual puppet comprising the steps of:
(a) tracking the movements of an operator;
(b) mapping the movements of the operator onto the virtual puppet; and
(c) controlling the virtual puppet in response to inputs by the operator in a remote control.

50. A method as claimed in claim 49, wherein said remote control is hand-held.

51. A method as claimed in claim 50, wherein said remote control is carried or supported by the operator.

52. A method as claimed in any one of claims claim 49, wherein said remote control is provided as a part of a glove.

53. A method as claimed in claim 49, wherein said remote control is one selected from a group consisting of: a switch, a joystick and a jog wheel.

54. A method of generating a virtual puppet as claimed in claim 49, wherein the remote control is operable to perform a step selected from a group consisting of: refining the movement of the virtual puppet; and changing the appearance of the virtual puppet.

55. A method of generating a virtual puppet as claimed in claim 49, wherein the virtual puppet is displayed on at least one display remote from the operator.

56. A method of generating a virtual puppet as claimed in claim 55, wherein said at least one display is connected over a system selected from a group consisting of: a LAN, a WAN and the Internet.

57. A method of generating a virtual puppet as claimed in claim 49, wherein the movements of the operator are simultaneously mapped onto a second virtual puppet.

58. A display system comprising a motion tracking system for tracking the movements of an operator, a processor for generating a virtual puppet, and a remote control operable by the operator to control the virtual puppet.

59. A display system as claimed in claim 58, wherein, in use, said remote control is hand-held.

60. A display system as claimed in claim 59, wherein, in use, said remote control is carried or supported by the operator.

61. A display system as claimed in claim 58 further comprising attachment means for attaching said controller to an operator's hand.

62. A display system as claimed in claim 58, wherein said remote control is provided on a glove.

63. A display system as claimed in claim 58, wherein said controller is one selected from a group consisting of: a switch, a joystick and a jog wheel.

64. An interactive system for use in a retail outlet, the system comprising a virtual puppet display system as claimed in claim 58.

65. An interactive system for placing an order, the system comprising at least one virtual puppet display system.

66. An interactive system as claimed in claim 65, wherein the system comprises a plurality of said virtual puppet display systems.

67. An interactive system as claimed in claim 66 further comprising a selection means to enable an operator to select which display system is active.

68. An interactive system as claimed in claim 65 further comprising payment receiving means.
